(19) United States
(12) Patent Application Publication
(10) Pub. No.: US 2013/0290761 A1
(43) Pub. Date: Oct. 31, 2013

(54) METHOD OF AND APPARATUS FOR PROCESSING TOUCH SIGNAL BY TOUCH SENSOR CONTROLLER

(71) Applicants: Byung-Joon Moon, Yongin-si (KR); Chul-Yong Joung, Yongin-si (KR); Jae-Surk Hong, Yongin-si (KR); Se-Eun Jang, Yongin-si (KR)

(72) Inventors: Byung-Joon Moon, Yongin-si (KR); Chul-Yong Joung, Yongin-si (KR); Jae-Surk Hong, Yongin-si (KR); Se-Eun Jang, Yongin-si (KR)

(73) Assignee: ATLAB INC., Yongin-si (KR)

(21) Appl. No.: 13/997,351

(22) PCT Filed: Jan. 13, 2012
(86) PCT No.: PCT/KR12/00334

§ 371 Date: Jun. 24, 2013

(30) Foreign Application Priority Data
Jan. 18, 2011 (KR) 10-2011-0005127

(51) Int. Cl. G06F 1/32; G06F 3/0488

(52) U.S. Cl. CPC G06F 1/32; G06F 3/0488
USPC 713/323; 345/173

(57) ABSTRACT

Provided are an apparatus and method by which a touch sensor controller of a touch screen apparatus may efficiently process a touch signal in response to a touch event to reduce power consumption of the entire system. An apparatus including a touch screen includes a touch sensor controller configured to generate a touch signal in response to a touch event and process the touch signal and a system controller configured to receive the touch signal from the touch sensor controller and perform an operation in response to the touch signal. The touch sensor controller determines whether the touch event is a multi-touch, generates touch signals having different types depending on whether the touch event is the multi-touch, and transmits the touch signals to the system controller. Thus, power consumption of the apparatus including the touch screen may be efficiently reduced.

### TECHNICAL FIELD

Embodiments of the inventive concept relate to a method and a apparatus by which a touch sensor controller processes a touch signal, and more particularly, to a method and a apparatus by which a touch sensor controller of a touch screen apparatus efficiently processes a touch signal in response to a touch event to reduce power consumption of the entire system.

### BACKGROUND ART

A touch-screen-type mobile terminal, such as a smart phone or a tablet personal computer (PC), may include a touch sensor sheet configured to sense a contact of a user with a screen, a display unit configured to display a user interface, a touch sensor controller configured to process a touch sensing signal output by the touch sensor sheet, and a system controller configured to receive a touch signal from the touch sensor controller and perform an operation in response to the touch signal.

Conventionally, after generating touch raw data as a digital-signal type in response to the touch sensing signal output by the touch sensor sheet, the touch sensor controller may process coordinates of the generated touch raw data and transmit the corresponding operation performance signal to the system controller or process a wake-up touch event and transmit the corresponding operation performance signal to the system controller.

Accordingly, the touch sensor controller may require an additional microprocessor unit (MPU) to perform a signal processing operation.

However, since an MPU used for the system controller enables 1-GHz high-speed operations and includes a large-capacity memory, the MPU for the system controller may process signals in response to the touch event instead of the additional MPU for the touch sensor controller having relatively low operating performance and a memory with a limited memory capacity. Therefore, adopting the additional MPU for the touch sensor controller to process signals may be inappropriate in terms of waste of resources.

However, when the system controller is configured to process all signals rather than the generation of touch raw data in response to a touch event regardless of single touch or multi-touch, it may be unsatisfactory in terms of power consumption because the system controller consumes power at a higher rate than the touch sensor controller.

Furthermore, conventionally, when the display unit is in a sleep mode and a user interface is locked, a user-interface unlock screen may be displayed by pushing a specific mechanical button to wake up a system, and the user-interface may be unlocked by making a specific gesture (e.g., moving a finger in a specific direction while contacting the finger with a specific region on a touch screen) on the user-interface unlock screen.

In this case, since the user-interface unlocking operation is performed while turning on both the display unit and the system controller, wasteful power consumption may occur.

### DISCLOSURE

### Technical Problem

The present invention is directed to providing an apparatus and method by which a touch sensor controller having a lower rate of power consumption than a system controller may process some signals in response to touch events to reduce power consumption of the entire system.

In addition, The present invention is directed to providing an apparatus and method by which, when a system controller is in a sleep mode, the system controller may wake up and simultaneously, an unlocked user interface may be displayed only in response to a specific touch event caused to a touch sensor sheet.

### Technical Solution

In accordance with an aspect of the inventive concept, a touch signal processing apparatus including a touch screen is provided. The apparatus includes a touch sensor controller configured to generate a touch signal in response to a touch event and process the touch signal and a system controller configured to receive the touch signal from the touch sensor controller and perform an operation in response to the touch signal. The touch sensor controller determines whether or not the touch event is a multi-touch, generates touch signals having different types depending on whether or not the touch event is the multi-touch, and transmits the touch signals to the system controller.

The touch signal may be a touch raw data type when the touch event is the multi-touch, and be a coordinate data type when the touch event is a single touch.

The touch sensor controller may search for system-controller mode determination information during generation of the touch event and determines a mode of the system controller, and the system controller may be in a sleep release mode.

When the system controller is in a sleep mode, the touch sensor controller may determine whether or not a display unit is displaying a sleep release screen. When the display unit is displaying the sleep release screen, the touch sensor controller may determine whether the touch event satisfies conditions set to release the system controller from the sleep mode, generate a sleep release signal to release the system controller from the sleep mode, and transmit the sleep release signal to the system controller.

The set conditions may include a condition where the touch event is the single touch.

The set conditions may include a condition where a gesture or pattern of the touch event matches a set gesture or pattern.

When the display unit is not displaying the sleep release screen, the touch sensor controller may control the display unit to display the sleep release screen.

The display unit may include a memory configured to store frame information for a sleep release screen and display the sleep release screen in response to a control signal output by the touch sensor controller.

When the touch event does not occur for a predetermined time during a display of the sleep release screen, the touch sensor controller may control the display unit to stop displaying the sleep release screen.

The touch sensor controller may control the display unit to stop displaying the sleep release screen during the transmission of the sleep release signal. When the system controller receives the sleep release signal, the system controller may wake up and control the display unit to display an unlocked user interface.

When the touch event does not occur for a predetermined time through the user interface, the system controller may transmit a sleep-mode initiation notification signal to the touch sensor controller and enters the sleep mode.

When the touch sensor controller receives the sleep-mode initiation notification signal, the touch sensor controller may control the display unit to display the sleep release screen.

In accordance with another aspect of the inventive concept, a touch signal processing apparatus comprising a touch screen is provided. The apparatus includes a touch sensor controller configured to, when a touch event occurs, perform a first determination operation of determining a mode of a system controller and a second determination operation of determining a type of the touch event, generate different touch signals based on results of the first and second determination operations, and transmit the touch signals to the system controller and the system controller configured to receive the touch signals and perform operations corresponding respectively to the different touch signals.

When it is determined in the first determination operation that the system controller is in a sleep release mode and it is determined in the second determination operation that the touch event is a single touch, the touch signal may be a coordinate data type corresponding to the touch event. When it is determined in the first determination operation that the system controller is in the sleep release mode and it is determined in the second determination operation that the touch event is a multi-touch, the touch signal may be a touch raw data type corresponding to the touch event.

When it is determined in the first determination operation that the system controller is in a sleep mode, the touch sensor controller may perform a third determination operation of releasing the system controller from the sleep mode, and the touch signal generated based on a result of the third determination operation may be a sleep release signal for releasing the system controller from the sleep mode.

In accordance with another aspect of the inventive concept, a method of processing a touch signal in response to a touch event by a touch sensor controller controlling a touch sensor sheet for a touch screen and connected to a system controller is provided. The method includes receiving a touch event, determining whether the system controller is in a sleep mode during occurrence of the touch event, determining whether a display unit is displaying a sleep release screen when the system controller is in the sleep mode, determining whether the touch event is a single touch when the display unit is displaying the sleep release screen, determining whether the touch event matches a set gesture or pattern when the touch event is the single touch, and transmitting a sleep release signal for releasing the system controller from the sleep mode to the system controller when the touch event matches the set gesture or pattern.

When the display unit is not displaying the sleep release screen, the method may further include controlling the display unit to display the sleep release screen, receiving a second touch event, determining whether the second touch event matches the set gesture or pattern when the second touch event is a single touch, and transmitting the sleep release signal for releasing the system controller from the sleep mode to the system controller when the second touch event matches the set gesture or pattern.

During the transmitting of the sleep release signal, the touch sensor controller may control the display unit to stop displaying the sleep release screen.

When the system controller is in a sleep release mode, the method may further include determining whether the touch event is a single touch or a multi-touch, transmitting coordinate data corresponding to the touch event to the system controller when the touch event is the single touch, and transmitting touch raw data corresponding to the touch event to the system controller when the touch event is the multi-touch.

When the system controller receives the sleep release signal, the system controller may wake up and control the display unit to display an unlocked user interface on the display unit.

### Advantageous Effects

According to embodiments of the inventive concept, some signals generated in response to touch events may be processed by a touch sensor controller having a lower rate of power consumption than a system controller, thereby reducing power consumption of the entire system.

In addition, by means of only a specific touch event caused to a touch sensor sheet in a sleep mode of the system controller, the system controller may wake up and simultaneously an unlocked user interface may be displayed, thereby reducing power consumption.

### DESCRIPTION OF DRAWINGS

FIG. 1 is a block construction diagram of an apparatus for processing a touch signal in response to a touch event on a touch screen according to embodiments of the inventive concept;

FIG. 2 is a block construction diagram of a touch sensor controller according to embodiments of the inventive concept;

FIG. 3 is a flowchart illustrating a method of processing a touch signal by a touch sensor controller according to embodiments of the inventive concept; and

FIG. 4 is an operation mode diagram of a system controller according to embodiments of the inventive concept.

### MODES OF THE INVENTION

Hereinafter, constructions and functions according to embodiments of the inventive concept will be described in detail with reference to the appended drawings.

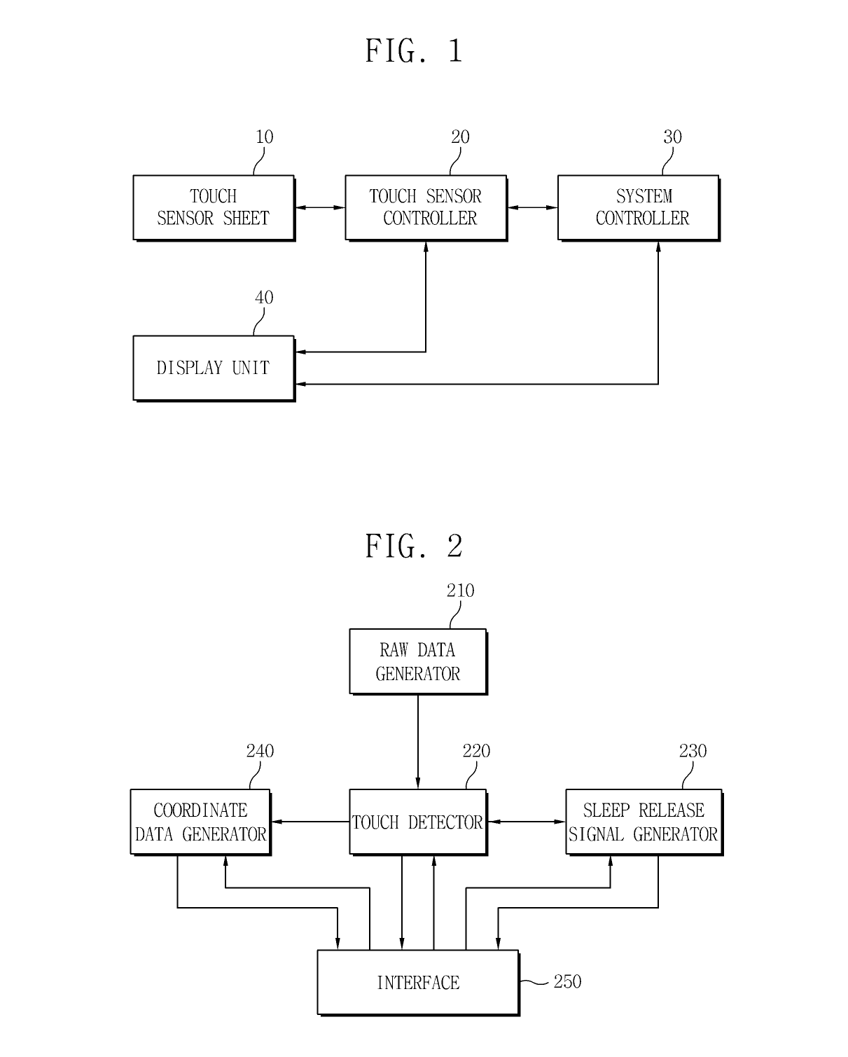

FIG. 1 is a block construction diagram of an apparatus for processing a touch signal in response to a touch event on a touch screen according to embodiments of the inventive concept.

A touch sensor sheet 10 may sense a touch event, such as a contact of a user's finger with a touch screen, in response to a touch sensor driver signal output by a touch sensor controller 20 and output a touch sensing signal to the touch sensor controller 20.

The touch sensing signal may include a capacitance of a sensor cell in the case of a capacitive touch sensor, and include a pressure value of a sensor cell in the case of a pressure touch sensor.

The touch sensor controller 20 may convert the touch sensing signal output by the touch sensor sheet 10 into touch raw data, which is a digital signal, and determine whether the generated touch event is a single touch or multi-touch using the touch raw data, differently process the touch raw data into a signal, and transmit the processed signal to a system controller 30.

In addition, a touch signal processing may be differently performed in response to the touch event depending on whether or not the system controller 30 is in a sleep mode. For example, when the system controller 30 is in the sleep mode, the touch sensor controller 20 may transmit a wake-up signal to the system controller 30 in response to occurrence of a specific touch event.

In this case, the sleep mode means that, for power saving, the system controller 30 ceases operations before the system controller 30 wakes up.

Also, the sleep release mode means that the system controller 30 is in a drive mode and an unlocked user interface is displayed on the touch screen.

In addition, when the system controller 30 is in the sleep mode, the touch sensor controller 20 may control a display unit 40 to display a sleep release screen or stop displaying the sleep release screen. For example, when the system controller 30 enters the sleep mode or when a touch event occurs in the sleep mode of the system controller 30 and the sleep release screen is in a non-display state, the touch sensor controller 20 may control the display unit 40 to display the sleep release screen. In contrast, in the display state of the sleep release screen, when the touch sensor sheet 10 does not recognize the touch event for a predetermined time (e.g., about 5 seconds) or a sleep release signal is transmitted to the system controller 30, the touch sensor controller 20 may control the display unit 40 to stop displaying the sleep release screen.

The system controller 30, which may control the entire system of a touch screen apparatus, may execute various programs stored in a storage unit (not shown), receive a wake-up signal from the touch sensor controller 20 to initiate an operation, and execute a user interface program stored in the storage unit so that the display unit 40 may display an unlocked user interface.

The display unit 40 may include a liquid crystal display (LCD) and display the unlocked user interface under the control of the system controller 30. Meanwhile, the display unit 40 may store sleep-release-screen frame information in a frame memory included therein and display or stop displaying the sleep release screen under the control of the touch sensor controller 20.

FIG. 2 is a block construction diagram of a touch sensor controller according to embodiments of the inventive concept.

A raw data generator 210 may receive the touch sensing signal, which is generated in response to the touch sensor driver signal applied to the touch sensor sheet (refer to 10 in FIG. 1), convert the touch sensing signal into touch raw data, which is a digital signal, and transmit the touch raw data to a touch detector 220.

The touch detector 220 may detect occurrence of a touch event using the touch raw data and determine whether the touch event is a multi-touch or single touch.

For example, as in the conventional case, the touch sensor sheet 10 may include a plurality of touch pads arranged in a matrix shape, and the plurality of touch pads may be configured to have respectively different shapes and generate respectively different contact signals to determine whether or not the touch event is the multi-touch and the number of touch events.

Furthermore, the touch detector 220 may store system-controller mode determination information indicating whether or not the system controller (refer to 30 in FIG. 1) is in a sleep mode and differently process the touch raw data based on whether or not the system-controller is in a sleep mode in response to the occurrence of the touch event.

For example, in a sleep release mode of the system controller 30, when the touch event is the multi-touch, the touch detector 220 may transmit the touch raw data and information regarding the number of touch events through an interface 250 to the system controller 30; while when the touch event is the single touch, the touch detector 220 may transmit the touch raw data to a coordinate data generator 240.

Next, when the system controller 30 is in the sleep mode, the touch detector 220 may determine whether the display unit (refer to 40 in FIG. 1) is displaying a sleep release screen. For example, the touch detector 220 may control the display unit 40 to display or stop displaying the sleep release screen through the interface 250 and comprehend whether or not the sleep release screen is displayed.

Thereafter, during a display of the sleep release screen, the touch detector 220 may discard the touch raw data when the touch event is the multi-touch, and transmit the touch raw data to a sleep release signal generator 230 when the touch event is the single touch. During a non-display of the sleep release screen, the touch detector 220 may control the display unit 40 to display the sleep release screen, discard the touch raw data when a touch event generated after the display of the sleep release screen is a multi-touch, and transmit the touch raw data to the sleep release signal generator 230 when the touch event generated after the display of the sleep release screen is a single touch. Here, it is natural that the sleep release screen can be any pattern with backlight-on or backlight-off.

When the system controller 30 cannot receive the touch raw data or coordinate data from the touch sensor controller (refer to 20 in FIG. 1) within a predetermined time (e.g., about 20 seconds) or cannot receive an input signal using another input unit, for example, a mechanical button, the system controller 30 may transmit a sleep mode initiation notification signal to the touch detector 220. The touch detector 220 may register the system controller 30 as being in the sleep mode in the system-controller mode determination information in response to the sleep mode initiation notification signal. Also, when the system controller 30 receives the sleep release signal from the touch sensor controller 20 and wakes up, the system controller 30 may transmit a sleep mode release notification signal to the touch detector 220. The touch detector 220 may register the system controller 30 as being in the sleep release mode in the system-controller mode determination information in response to the sleep mode release notification signal.

In addition, when the touch detector 220 receives the sleep mode initiation notification signal, the touch detector 220 may control the display unit 40 to display the sleep release screen.

In addition, the touch detector 220 may receive a sleep release signal transmission signal from sleep release signal generator 230 and control the display unit 40 to stop displaying the sleep release screen in response to the sleep release signal transmission signal.

The sleep release signal generator 230 may analyze the touch raw data and determine whether or not a gesture or pattern made in response to the touch event matches a stored sleep release set gesture or pattern.

The determination process may be performed using a conventional gesture discrimination algorithm or pattern recognition algorithm.

When the gesture or pattern made in response to the touch event matches the sleep release set gesture or pattern, the sleep release signal generator 230 may generate a sleep release signal and transmit the sleep release signal to the system controller 30 through the interface 250 and transmit the sleep release signal transmission signal to the touch detector 220. When the gesture or pattern made in response to the touch event does not match the sleep release set gesture or pattern, the sleep release signal generator 230 may ignore the touch event.

The sleep release signal generator 230 may store information regarding the sleep release set gesture or pattern transmitted from the system controller 30 in a storage device included therein.

The sleep release set gesture or pattern may be directly set by a user through an input window provided through a user interface or set by selecting any one of gestures or patterns provided by the user interface during the drive of the system controller.

The coordinate data generator 240 may receive various parameters required for transformation of the coordinates of a touch point from the system controller 30, store the various parameters, convert the touch raw data transmitted from the touch detector 220 into coordinate data, and transmit the converted coordinate data to the system controller 30 through the interface 250.

The interface 250 may enable various signals and data to be transmitted to and received from the system controller 30 and the display unit 40.

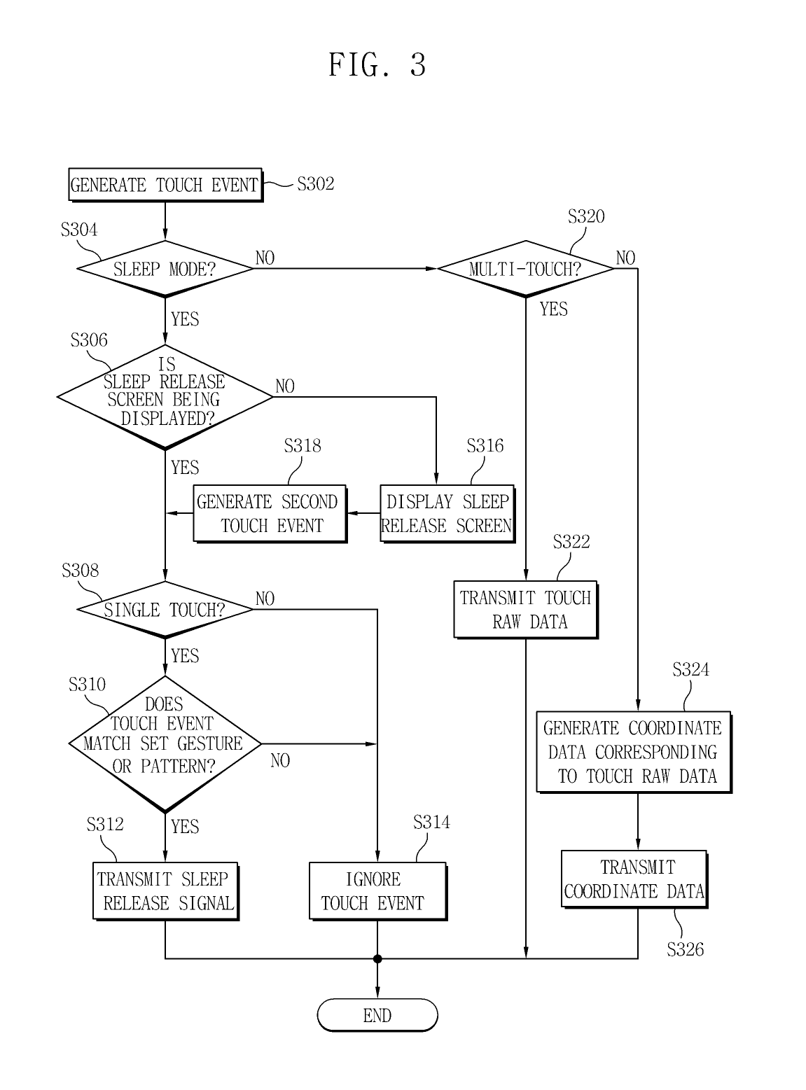

FIG. 3 is a flowchart illustrating a method of processing a touch signal by a touch sensor controller according to embodiments of the inventive concept.

To begin with, when a touch event occurs by means of a touch sensor sheet, a touch sensing signal generated in response to the touch event may be converted into touch raw data, which is a digital signal (operation S302).

Next, the occurrence of the touch event may be recognized, and it may be determined whether or not a system controller is in a sleep mode by searching for stored system-controller mode determination information (operation S304).

Next, when it is determined in operation S304 that the system controller is in the sleep mode, it may be determined whether a display unit is displaying a sleep release screen (operation S306).

Next, when it is determined in operation S306 that the display unit is displaying the sleep release screen, it may be determined whether the touch event is a single touch or a multi-touch (operation S308).

Next, when it is determined in operation S308 that the touch event is the single touch, it may be determined that a gesture or pattern of the touch event matches a set sleep release set gesture or pattern (operation S310).

Next, when it is determined in operation S310 that the gesture or pattern of the touch event matches the sleep release set gesture or pattern, a sleep release signal may be generated and transmitted to the system controller (operation S312).

The system controller to which the sleep release signal is transmitted may wake up in response to the sleep release signal, execute a user interface program, and control a display unit to display an unlocked user interface on the display unit.

Next, when it is determined in operation S308 that the touch event is not the single touch and it is determined in operation S310 that the gesture or pattern of the touch event does not match the sleep release set gesture or pattern, the touch event may be ignored (operation S314).

Next, when it is determined in operation S306 that the sleep release screen is not displayed, either the system controller or the touch sensor controller may control the display unit to display the sleep release screen (operation S316).

Next, occurrence of a second touch event may be recognized (operation S318), and operations S308 through S314 may be performed in response to the second touch event.

Next, when it is determined in operation S304 that the system controller is in the sleep release mode, it may be determined whether the touch event is a multi-touch or single touch (operation S320).

Next, when it is determined in operation S320 that the touch event is the multi-touch, the touch raw data may be transmitted to the system controller (operation S322).

The system controller to which the touch raw data is transmitted may analyze and process the received touch raw data and perform an operation corresponding to the touch event.

Next, when it is determined in operation S320 that the touch event is the single touch, coordinate data corresponding to the touch raw data may be generated (operation S324) and transmitted to the system controller (operation S326).

The system controller to which the coordinate data is transmitted may analyze and process the received coordinate data and perform an operation corresponding to the touch event.

The above-described touch event for a sleep release mode may be not only a drag-type gesture or pattern but also a click-type event for inputting a specific number or region to the sleep release screen.

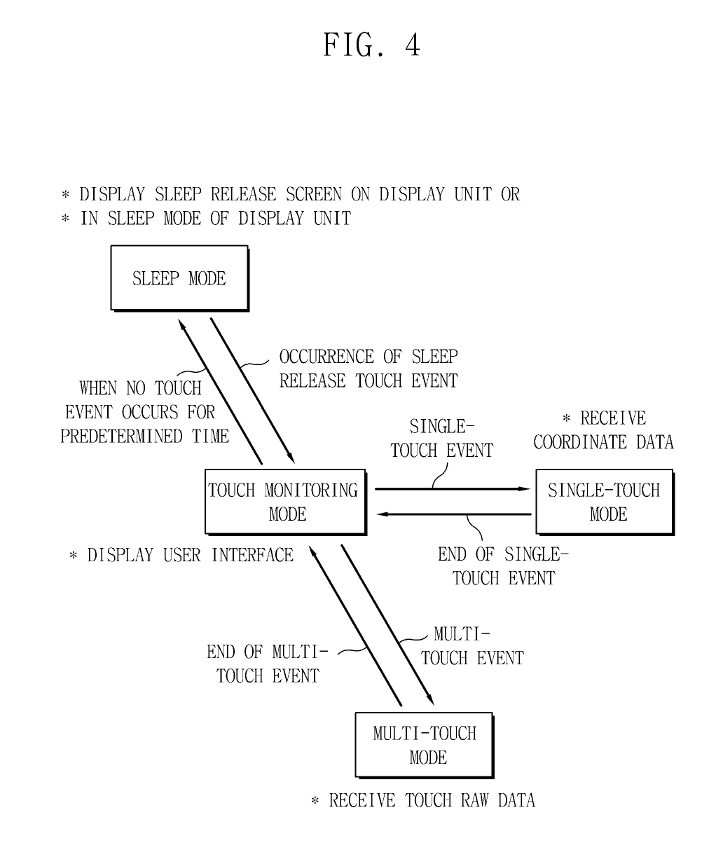

FIG. 4 is an operation mode diagram of a system controller according to embodiments of the inventive concept.

When the system controller is in a sleep mode, a display unit may be in a sleep mode so as not to display a user interface and a sleep release screen or be displaying the sleep release screen, while a touch sensor module including a touch sensor sheet and a touch sensor controller may be in a drive mode.

When a sleep release touch event occurs in the sleep mode (e.g., when the touch event is a single touch and has a specific gesture or pattern), the system controller may wake up and enter a touch monitoring mode, and an unlocked user interface may be displayed on the display unit. In this case, a sleep mode release notification signal may be transmitted to a touch sensor controller.

When no touch event occurs for a predetermined time (e.g., about 20 seconds) in the touch monitoring mode, the system controller may enter the sleep mode. In this case, a sleep mode initiation notification signal may be transmitted to the touch sensor controller.

When a single touch event occurs in the touch monitoring mode, the system controller may operate in a single-touch mode. In this case, the system controller may receive coordinate data corresponding to the touch event from the touch sensor controller, and enter the touch monitoring mode when the touch event ends.

When a multi-touch event occurs in the touch monitoring mode, the system controller may operate in a multi-touch mode. In this case, the system controller may receive touch raw data corresponding to the touch event from the touch sensor controller, process the received touch raw data, and enter the touch monitoring mode when the touch event ends.

The present invention relates to a method and apparatus of processing a signal in response to touch event by a touch screen apparatus, can be usefully used in an industry relating to an apparatus comprising a touch screen.

While the invention has been shown and described with reference to certain exemplary embodiments thereof, it will be understood by those skilled in the art that various changes in form and details may be made therein without departing from the spirit and scope of the invention as defined by the appended claims.

1. A touch signal processing apparatus comprising a touch screen, the apparatus comprising:
a touch sensor controller configured to generate a touch signal in response to a touch event and process the touch signal; and
a system controller configured to receive the touch signal from the touch sensor controller and perform an operation in response to the touch signal,
wherein the touch sensor controller determines whether or not the touch event is a multi-touch, generates touch signals having different types depending on whether or not the touch event is the multi-touch, and transmits the touch signals to the system controller.

2. The apparatus of claim 1, wherein the touch signal is a touch raw data type when the touch event is the multi-touch, and is a coordinate data type when the touch event is a single touch.

3. The apparatus of claim 2, wherein the touch sensor controller searches for system-controller mode determination information during generation of the touch event and determines a mode of the system controller, and
the system controller is in a sleep release mode.

4. The apparatus of claim 3, wherein, when the system controller is in a sleep mode, the touch sensor controller determines whether or not a display unit is displaying a sleep release screen, and
when the display unit is displaying the sleep release screen, the touch sensor controller determines whether the touch event satisfies conditions set to release the system controller from the sleep mode, generates a sleep release signal to release the system controller from the sleep mode, and transmits the sleep release signal to the system controller.

5. The apparatus of claim 4, wherein the set conditions include a condition where the touch event is the single touch.

6. The apparatus of claim 5, wherein the set conditions include a condition where a gesture or pattern of the touch event matches a set gesture or pattern.

7. The apparatus of claim 4, wherein, when the display unit is not displaying the sleep release screen, the touch sensor controller controls the display unit to display the sleep release screen.

8. The apparatus of claim 7, wherein the display unit includes a memory configured to store frame information for a sleep release screen and display the sleep release screen in response to a control signal output by the touch sensor controller.

9. The apparatus of claim 8, wherein, when the touch event does not occur for a predetermined time during a display of the sleep release screen, the touch sensor controller controls the display unit to stop displaying the sleep release screen.

10. The apparatus of claim 4, wherein the touch sensor controller controls the display unit to stop displaying the sleep release screen during the transmission of the sleep release signal,
wherein, when the system controller receives the sleep release signal, the system controller wakes up and controls the display unit to display an unlocked user interface.

11. The apparatus of claim 10, wherein, when the touch event does not occur for a predetermined time through an user interface, the system controller transmits a sleep-mode initiation notification signal to the touch sensor controller and enters the sleep mode.

12. The apparatus of claim 11, wherein, when the touch sensor controller receives the sleep-mode initiation notification signal, the touch sensor controller controls the display unit to display the sleep release screen.

13. A touch signal processing apparatus comprising a touch screen, the apparatus comprising:
a touch sensor controller configured to, when a touch event occurs, perform a first determination operation of determining a mode of a system controller and a second determination operation of determining a type of the touch event, generate different touch signals based on results of the first and second determination operations, and transmit the touch signals to the system controller; and
the system controller configured to receive the touch signals and perform operations corresponding respectively to the different touch signals.

14. The apparatus of claim 13, wherein, when it is determined in the first determination operation that the system controller is in a sleep release mode and it is determined in the second determination operation that the touch event is a single touch, the touch signal is a coordinate data type corresponding to the touch event, and
when it is determined in the first determination operation that the system controller is in the sleep release mode and it is determined in the second determination operation that the touch event is a multi-touch, the touch signal is a touch raw data type corresponding to the touch event.

15. The apparatus of claim 13, wherein, when it is determined in the first determination operation that the system controller is in a sleep mode, the touch sensor controller performs a third determination operation of releasing the system controller from the sleep mode, and the touch signal generated based on a result of the third determination operation is a sleep release signal for releasing the system controller from the sleep mode.

16. A method of processing a touch signal in response to a touch event by a touch sensor controller controlling a touch sensor sheet for a touch screen and connected to a system controller, the method comprising:
receiving a touch event;
determining whether the system controller is in a sleep mode during occurrence of the touch event;
determining whether a display unit is displaying a sleep release screen when the system controller is in the sleep mode;
determining whether the touch event is a single touch when the display unit is displaying the sleep release screen;
determining whether the touch event matches a set gesture or pattern when the touch event is the single touch; and
transmitting a sleep release signal for releasing the system controller from the sleep mode to the system controller when the touch event matches the set gesture or pattern.

17. The method of claim 16, further comprising: when the display unit is not displaying the sleep release screen,
controlling the display unit to display the sleep release screen;
receiving a second touch event;
determining whether the second touch event matches the set gesture or pattern when the second touch event is a single touch; and
transmitting the sleep release signal for releasing the system controller from the sleep mode to the system controller when the second touch event matches the set gesture or pattern.

18. The method of claim 17, wherein, during the transmitting of the sleep release signal, the touch sensor controller controls the display unit to stop displaying the sleep release screen.

19. The method of claim 16, when the system controller is in a sleep release mode, further comprising:
determining whether the touch event is a single touch or a multi-touch; and
transmitting coordinate data corresponding to the touch event to the system controller when the touch event is the single touch, and transmitting touch raw data corresponding to the touch event to the system controller when the touch event is the multi-touch.

20. The method of claim 16, wherein, when the system controller receives the sleep release signal, the system controller wakes up and controls the display unit to display an unlocked user interface.
